(19) United States
(12) Patent Application Publication
(10) Pub. No.: US 2016/0136898 A1
(43) Pub. Date: May 19, 2016

(54) APPARATUS AND METHOD FOR CONTROL OF THREE DIMENSIONAL PRINTING

(71) Applicant: SAMSUNG SDS CO., LTD., Seoul (KR)

(72) Inventors: Sung-Ho JANG, Seoul (KR); In-Hyok CHA, Seoul (KR); Yong-Wook JEONG, Seoul (KR); Sang-Hoon HAN, Seoul (KR); Kwang-Min CHOI, Seoul (KR); Jae-Young PARK, Seoul (KR)

(73) Assignee: SAMSUNG SDS CO., LTD., Seoul (KR)

(21) Appl. No.: 14/940,790

(22) Filed: Nov. 13, 2015

(30) Foreign Application Priority Data
Nov. 14, 2014 (KR) 10-2014-0159099

(51) Int. Cl. B29C 67/00; G05B 19/4099

(52) U.S. Cl. CPC B29C 67/0088; G05B 19/4099; B33Y 10/00

(57) ABSTRACT

Disclosed are an apparatus and method for control of 3D printing. The apparatus includes a color data generation unit configured to generate entity-specific color data representing a color of each entity forming a 3D object based on modeling information about the 3D object, a color quantization unit configured to convert the entity-specific color data to represent one of a plurality of output-able colors as the color of each entity, and an output file generation unit configured to generate an output file to be used for output of the 3D object from the modeling information and the converted entity-specific color data.

### CROSS-REFERENCE TO RELATED APPLICATION

This application claims priority to and the benefit of Korean Patent Application No. 10-2014-0159099, filed on Nov. 14, 2014, the disclosure of which is incorporated herein by reference in its entirety.

### BACKGROUND

1. Field

The present disclosure relates to an apparatus and method for control of three-dimensional printing, and more particularly, to a technology for control of multicolor three-dimensional printing.

2. Discussion of Related Art

Three-dimensional printing (3D printing) is used to output a 3D object having a stereoscopic appearance by ejecting printing materials, such as solid, powder, and liquid polymer, and laminating the materials. Most of the existing 3D printers produce resulting items having a monotonous color. Therefore, instead of the 3D printers having such a constraint, a next generation 3D printer that can output multicolor resulting items using various types of material is grabbing interests.

However, the multicolor-based 3D printing has inconvenience in use. In some examples of the multicolor-based 3D printing method, a user needs to designate a printing material or printing color for a 3D object by using additional software. In other examples, a 3D object file supporting multicolor may be used to perform multicolor 3D printing, but a user needs to use specific colors that are able to be output by a 3D printer from a stage of modeling a 3D object. Different from the above, a 3D object may be modeled using unique colors at a 3D modeling tool (for example, Ser. No. 16/777,216 colors), but it is difficult to apply the modeling information as it is to an output through a 3D printer that supports limited materials and colors. In addition, colors being able to be output by a 3D printer may be different depending on the specifications of the 3D printers.

Accordingly, there is a need for new technology of effectively performing multicolor 3D printing according to specifications of 3D printers by using an output file for a 3D object without having additional software or the user's designation of colors.

### SUMMARY

The present disclosure is directed to an apparatus and method for control of multicolor 3D printing, capable of controlling a task of outputting a 3D object in various colors.

According to an aspect of the present disclosure, there is provided an apparatus for control of three-dimensional printing (3D printing), the apparatus including a color data generation unit, a color quantization unit and an output file generation unit. The color data generation unit may be configured to generate entity-specific color data representing a color of each entity forming a 3D object based on modeling information about the 3D object. The color quantization unit may be configured to convert the entity-specific color data to represent one of a plurality of output-able colors as the color of each entity. The output file generation unit may be configured to generate an output file to be used for output of the 3D object from the modeling information and the converted entity-specific color data.

The color data generation unit may identify the entity by extracting appearance information about the 3D object from the modeling information, and may generate the entity-specific color data by extracting at least one of texture information about the 3D object and color information about the 3D object from the modeling information.

The output file may include the converted entity-specific color data together with the appearance information.

The apparatus may further include a color filter information generation unit configured to generate color filter information representing the plurality of output-able colors. The color quantization unit may convert the entity-specific color data by using the color filter information, and the color filter information and the entity-specific color data may represent the plurality of output-able colors and the color of each entity, respectively, according to a predetermined color model.

The color model may be selected among models that are usable for quantifying colors of the 3D object.

The color quantization unit may identify an output-able color having a minimum distance to the color of each entity among the plurality of output-able colors by calculating distances between the color of each entity and the plurality of output-able colors according to a predetermined distance metric, and may convert the entity-specific color data to represent the identified output-able color as the color of each entity.

The apparatus may further include a color filter information generation unit configured to generate color filter information representing the plurality of output-able colors. The distance may be a distance between a first coordinate value and a second coordinate value, and the first coordinate value may be a coordinate value represented by the color filter information in a color space according to a color model as the respective output-able colors, and the second coordinate value may be a coordinate value represented by the entity-specific color data in the color space as the color of each entity.

The plurality of output-able colors may be colors designated as being able to be output by a 3D printer.

The apparatus may further include a control command generation unit and a control command transmission unit. The control command generation unit may be configured to generate at least one of per-layer image data and a control command for output of the 3D object based on the output file. The control command transmission unit may be configured to transmit the per-layer image data to the 3D printer when the per-layer image data is generated, or transmit the control command to the 3D printer when the control command is generated.

With respect to each of a plurality of candidate 3D printers, the color quantization unit may repeat the converting of the entity-specific color data, and the output file generation unit may repeat the generating of the output file. The output file generation unit may display an image of an expected resulting item of output of the 3D object through each of the candidate 3D printers by using the output file for each of the candidate 3D printers, and may detect a user's input to select one of the plurality of candidate 3D printers. The apparatus for control of 3D printing may further include a control command generation unit and a control command transmission unit. The control command generation unit may be configured to generate at least one of per-layer image data and a control command for output of the 3D object based on the output file for the selected candidate 3D printer. The control command transmission unit may be configured to transmit the per-layer image data to the selected candidate 3D printer when the per-layer image data is generated or transmit the control command to the selected candidate 3D printer when the control command is generated.

According to another aspect of the present disclosure, there is provided a method for control of three-dimensional printing (3D printing), the method including: generating entity-specific color data representing a color of each entity forming a 3D object based on modeling information about the 3D object; converting the entity-specific color data to represent one of a plurality of output-able colors as the color of each entity; and generating an output file to be used for output of the 3D object from the modeling information and the converted entity-specific color data.

The generating of the entity-specific color data may include: identifying the entity by extracting appearance information about the 3D object from the modeling information; and generating the entity-specific color data by extracting at least one of texture information about the 3D object and color information about the 3D object from the modeling information.

The output file may include the converted entity-specific color data together with the appearance information.

The method may further include generating color filter information representing the plurality of output-able colors, wherein the converting of the entity-specific color data may include converting the entity-specific color data by using the color filter information, and the color filter information and the entity-specific color data may represent the plurality of output-able colors and the color of each entity, respectively, according to a predetermined color model.

The color model may be selected among models that are usable for quantifying colors of the 3D object.

The converting of the entity-specific color data may include: identifying an output-able color having a minimum distance to the color of each entity among the plurality of output-able colors by calculating distances between the color of each entity and the plurality of output-able colors according to a predetermined distance metric; and converting the entity-specific color data to represent the identified output-able color as the color of each entity.

The method may further include generating color filter information representing the plurality of output-able colors, wherein the distance may be a distance between a first coordinate value and a second coordinate value, and the first coordinate value may be a coordinate value represented by the color filter information in a color space according to a color model as the respective output-able colors, and the second coordinate value may be a coordinate value represented by the entity-specific color data in the color space as the color of each entity.

The plurality of output-able colors may be colors designated as being able to be output by a 3D printer.

The method may further include: generating at least one of per-layer image data and a control command for output of the 3D object based on the output file; and transmitting the per-layer image data to the 3D printer when the per-layer image data is generated, or transmitting the control command to the 3D printer when the control command is generated.

The method may further include: with respect to each of a plurality of candidate 3D printers, repeating the converting of the entity-specific color data and the generating of the output file; displaying an image of an expected resulting item of output of the 3D object through each of the candidate 3D printers by using the output file for each of the candidate 3D printers; detecting a user's input to select one of the plurality of candidate 3D printers; generating at least one of per-layer image data and a control command for output of the 3D object based on the output file for the selected candidate 3D printer; and transmitting the per-layer image data to the selected candidate 3D printer when the per-layer image data is generated or transmitting the control command to the selected candidate 3D printer when the control command is generated.

According to still another aspect of the present disclosure, there is provided a computer program stored in a storage medium to execute the above-described method for control of 3D printing in combination with hardware.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating a 3D printing system according to an exemplary embodiment of the present disclosure;

FIG. 2 is a diagram illustrating color filter information according to an exemplary embodiment of the present disclosure;

FIG. 3 is a diagram illustrating entity-specific color data according to an exemplary embodiment of the present disclosure;

FIG. 4 is a flowchart showing a process of controlling multicolor 3D printing according to an exemplary embodiment of the present disclosure;

FIG. 5 is a flowchart showing a process of generating entity-specific color data according to an exemplary embodiment of the present disclosure;

FIG. 6 is a flowchart showing a process of quantizing entity-specific color data according to an exemplary embodiment of the present disclosure;

FIG. 7 is a diagram illustrating a pseudo-code representing operations of quantizing entity-specific color data according to an exemplary embodiment of the present disclosure;

FIG. 8 is a diagram illustrating a part of an output file according to an exemplary embodiment of the present disclosure; and

FIG. 9 is a flowchart showing a process of controlling multicolor 3D printing suitable for an operating environment in which a plurality of 3D printers exist.

### DETAILED DESCRIPTION OF EXEMPLARY EMBODIMENTS

Exemplary embodiments of the present disclosure will be described in detail below with reference to the accompanying drawings. The following description is intended to provide a comprehensive understanding of the method, apparatus and/or system described in the specification, but it is illustrative in purpose only and should not be construed as limiting the present disclosure.

In describing the present disclosure, detailed descriptions that are well-known and are likely to obscure the subject matter of the present disclosure will be omitted in order to avoid redundancy. The terminology used herein is defined in consideration of its function in the present disclosure, and may vary with an intention of a user and an operator or custom. Accordingly, the definition of the terms should be determined based on overall contents of the specification. The terminology used herein is for the purpose of describing particular embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

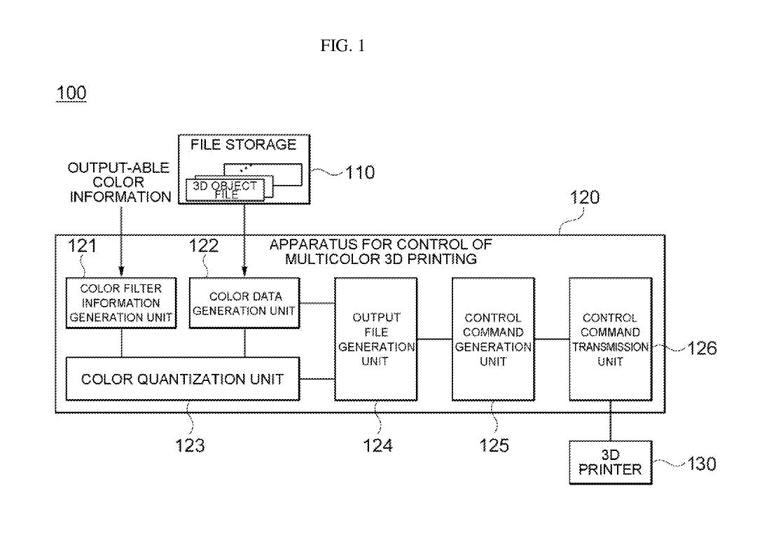

FIG. 1 is a block diagram illustrating a 3D printing system according to an exemplary embodiment of the present disclosure. Referring to FIG. 1, a 3D printing system 100 includes a file storage 110, an apparatus for control of multicolor 3D printing 120 and a 3D printer 130.

The file storage 110 is configured to store a 3D object file that provides modelling information about a 3D object. For example, the file storage 110 may store 3D object files including color information and texture information about objects together with appearance information about objects and having various formats, for example, a Computer Aided Design (CAD) file, a Digital Asset Exchange (DAE) file, an OBJ file, an Extensible 3D (X3D) file, a Reality Modeling Language (WRL) file. The description of formats is illustrative purpose only, and the file storage 110 may store 3D object files in other formats, for example, a STereoLithography (STL) format and Additive Manufacturing File (AMF) format.

According to exemplary embodiments of the present disclosure, the file storage 110 may include a computer-readable storage medium (for example, a hard disk and/or memory) in a computing apparatus (for example, a host computer connected to the 3D printer 130 or a computer in which the apparatus for control of multicolor 3D printing 120 is implemented), a local storage such as Direct-Attached Storage (DAS), a network storage such as Network-Attached Storage (NAS) and Storage Area Network (SAN), and/or a cloud storage. A user of the 3D printing system 100 may generate a desired 3D object file by using a 3D modeling tool, such as a 3D scanner, a CAD program, and a 3D image conversion program, and store the generated 3D object file in the file storage 110, or may download a 3D object file to the file storage 110 from a 3D content market (for example, Thingiverse), a cloud-based 3D printing service (for example, iMaterialise) and other 3D object file sharing systems via a network.

A user may select a 3D object file stored in the file storage 110 and request output of a 3D object represented by the 3D object file. The apparatus for control of multicolor 3D printing 120 may receive the user's request and acquire the selected 3D object file from the file storage 110. In particular, according to exemplary embodiments of the present disclosure, under the control of the apparatus for control of multicolor 3D printing 120, the 3D printer 130 may output the 3D object, for which output is requested, as a physical resulting item having various colors.

For example, the apparatus for control of multicolor 3D printing 120 may perform the following control operations. The apparatus for control of multicolor 3D printing 120 may acquire modeling information about a 3D object by using a 3D object file. Further, the apparatus for control of multicolor 3D printing 120 may generate entity-specific color data of the 3D object from the acquired 3D modeling information. Then, the apparatus for control of multicolor 3D printing 120 may perform a color quantization of converting the entity-specific color data to match an output-able color supported by the 3D printer. The apparatus for control of multicolor 3D printing 120 may generate an output file by using the entity-specific color data customized to the 3D printer 130 together with appearance information about the 3D object (for example, geometric information that represents a shape of the surface of the 3D object and is extractable from the 3D modeling information). The apparatus for control of multicolor 3D printing 120 may generate a control command to output the 3D object based on the output file, and transmit the generated control command to the 3D printer 130.

The 3D printer 130 may manufacture a resulting item having a stereoscopic shape using printing materials of various colors (for example, solid, powder, liquid, such as liquid polymer) by performing an output process according to the received control command.

Hereinafter, the apparatus for control of multicolor 3D printing 120 according to an exemplary embodiment of the present disclosure will be described.

Referring to FIG. 1, the apparatus for control of multicolor 3D printing 120 includes a color filter information generation unit 121, a color data generation unit 122, a color quantization unit 123, an output file generation unit 124, a control command generation unit 125 and a control command transmission unit 126. The modules of the apparatus for control of multicolor 3D printing 120 may be each implemented as hardware. For example, examples of the hardware may include a processor, a computer-readable storage medium accessible by a processor (for example, a volatile memory, a non-volatile memory and/or a storage device), an input device (for example, a pointing device, such as a mouse, a keyboard, a touch sense input device, and a voice input device, such as a microphone), an output device (for example, a display device, a printer, a speaker and/or a network card) and/or at least one external device, and an interface device supporting communication with an input device and/or an output device. According to exemplary embodiments, the apparatus for control of multicolor 3D printing 120 may be implemented or included in a computing device, such as a host computer connected to the 3D printer 130 (for example, via a serial port or a parallel port), or a computing device, such as a server computer connected to the 3D printer 130 via a network. According to other exemplary embodiments, the apparatus for control of multicolor 3D printing 120 may be implemented or included in the 3D printer 130.

The color filter information generation unit 121 may receive information about designating a plurality of colors being able to be output by the 3D printer 130 selected by a user for output (hereinafter, referred to as “output-able color information”). The apparatus for control of multicolor 3D printing 120 may generate color filter information by using the output-able color information. The color filter information may represent a plurality of output-able colors supported by the 3D printer 130 according to a predetermined color model. Examples of the color model may include various types of color models being able to be used by the 3D printer 130 (for example, an RGB model, a CMY model, an HIS model and a YCbCr model that are able to be used for quantification of colors of a 3D object).

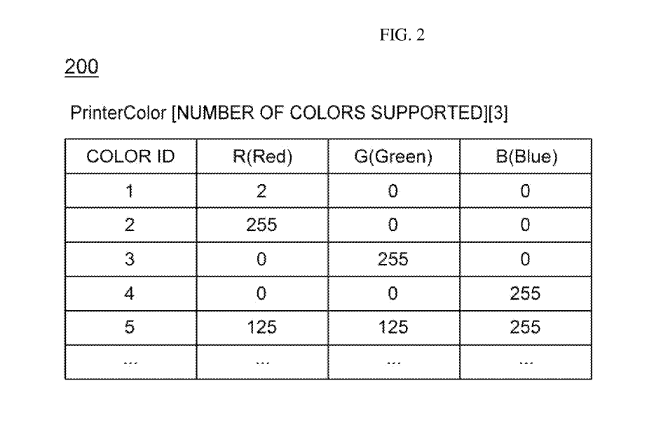

For convenience sake of description, it is assumed that the color filter information generation unit 121 generates color filter information representing output-able colors in a data structure such as a 3D vector array 200 named “PrinterColor” as shown in FIG. 2 according to an RGB model. For example, referring to FIG. 2, the 3D vector array 200 may represent an output-able color identified as an ID “5” as values of 125, 125 and 225 with respect to red, green and blue, respectively. The size of the 3D vector array 200 is equal to the number of output-able colors times 3. However, the color filter information is illustrative purpose only, and it may have another type of data structure.

The color data generation unit 122 may acquire modeling information about a 3D object. For example, as described above, a user may select a 3D object file stored in the file storage 110, and request output of a 3D object represented by the 3D object file. The color data generation unit 122 may receive the 3D object file from the file storage 110 in response to the user's request. The 3D object file may include modeling information about the 3D object. For example, the 3D object file may include appearance information about the 3D object. Further, the 3D object file may further include texture information and/or color information about the 3D object.

Accordingly, the color data generation unit 122 may extract appearance information about the 3D object from the 3D object file. The color data generation unit 122 may identify entities forming the 3D object based on the extracted appearance information. Each entity of the 3D object may be an entity in a unit designated by default, or may be an entity in a unit designated by the user to set a color. For example, each entity may be an entity forming an appearance of a 3D object, e.g. an “Object” entity representing the entire appearance of a 3D object, a “Part” entity representing a divided part of an “Object” entity, a “Polygon Mesh” entity forming an “Object” entity and/or a “Part” entity, such as a triangle used in an STL format, a “Voxel” entity representing an “Object” entity or a “Polygon Mesh” entity as a plurality of unit pixels each having a volume, or a “Layer” entity corresponding to one layer when an “Object” entity is divided into a plurality of layers for 3D printing according to a laminating method.

In addition, the color data generation unit 122 may extract other information about the 3D object from the 3D object file. The information may include color information about a color mapping to each entity of the 3D object and/or texture information about a texture map allocated to the 3D object. Based on the extracted information, the color data generation unit 122 may generate entity-specific color data representing a color of each entity forming the 3D object. The entity-specific color data may represent the color of each entity according to a predetermined color model (for example, an RGB model, a CMY model, an HIS model or a YCbCr model) described above.

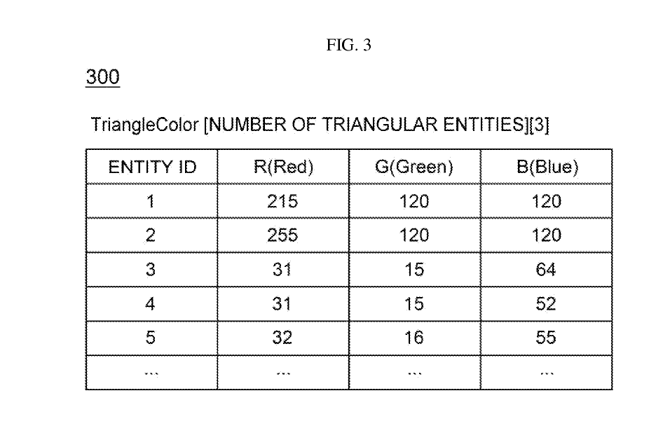

For example, the color data generation unit 122 may identify each entity forming a 3D object as a “Polygon Mesh”, that is, as a triangular entity, and according to an RGB model, may generate the entity-specific color data in a data structure, such as a 3D vector array 300, named “TriangleColor” as shown in FIG. 3. For example, referring to FIG. 3, the 3D vector array 300 may represent a triangular entity identified as ID “4” as values of 31, 15 and 52 with respect to red, green and blue, respectively. The size of the 3D vector array 300 is equal to the number of identified entities of the 3D object times 3. In addition, when texture information is mapped to the triangle, in order to represent more sophisticated colors, “Voxel” entity-specific color data may be generated as a data structure according to a color model based on a texture image mapping to a plurality of “Voxel” entities forming a triangle rather than based on a texture image mapped to the triangle. The description of the data structure is illustrative purpose only, and the entity-specific color data may have other types of data structure.

The color quantization unit 123 may use the color filter information to convert the entity-specific color data such that one of output-able colors supported by the 3D printer 130 is represented. The color quantization unit 123 may quantize the entity-specific color data through the conversion. For example, the converted entity-specific color data may represent the color of each entity as a color considered the most similar to an original color of the entity represented by the color information, among output-able colors represented by the color filter information according to a predetermined standard, not as the original color.

Based on the converted (that is, the quantized) entity-specific color data and the modeling information about the 3D object (in particular, appearance information about the 3D object), the output file generation unit 124 may generate an output file to be used for output of the 3D object through the 3D printer 130 (for example, an STL file, an AMF file or a 3D modeling file capable of representing color information), generate a 2D image of an expected resulting item of output of the 3D object through the 3D printer 130, and display the 2D image on the display device. A user may check the displayed image, and if desired to output the 3D object, may perform an input to initiate output of the 3D object.

In response to the user's input, the control command generation unit 125 may generate a control command to output the 3D object based on the output file. The control command transmission unit 126 may transmit the generated control command to the 3D printer 130. To this end, the control command transmission unit 126 may be provided with a communication protocol supporting a serial connection, a parallel connection and/or a network connection with the 3D printer 130. The 3D printer 130 may perform an output process for the 3D object by using the control command while manipulating a header and/or a print bed of the 3D printer 130.

For example, the output file may have 3D modeling information on which the converted entity-specific color data is reflected (for example, polygon data related to a “Polygon Mesh” entity of a 3D object). The control command generation unit 125 may slice the 3D modelling information (according to a layer thickness previously determined by a user of the 3D printing system 100 or by the apparatus for control of multicolor 3D printing 120) so as to produce a set of per-layer image data represented in a bitmap. The control command generation unit 125 may generate a control command to designate a path for ejecting a material, a printer header to represent a color, a speed of laminating materials and/or a thickness of the material layer in an output process of the 3D printer 130. According to the control command, the 3D printer 130 may laminate the materials layer by layer for output of the 3D object.

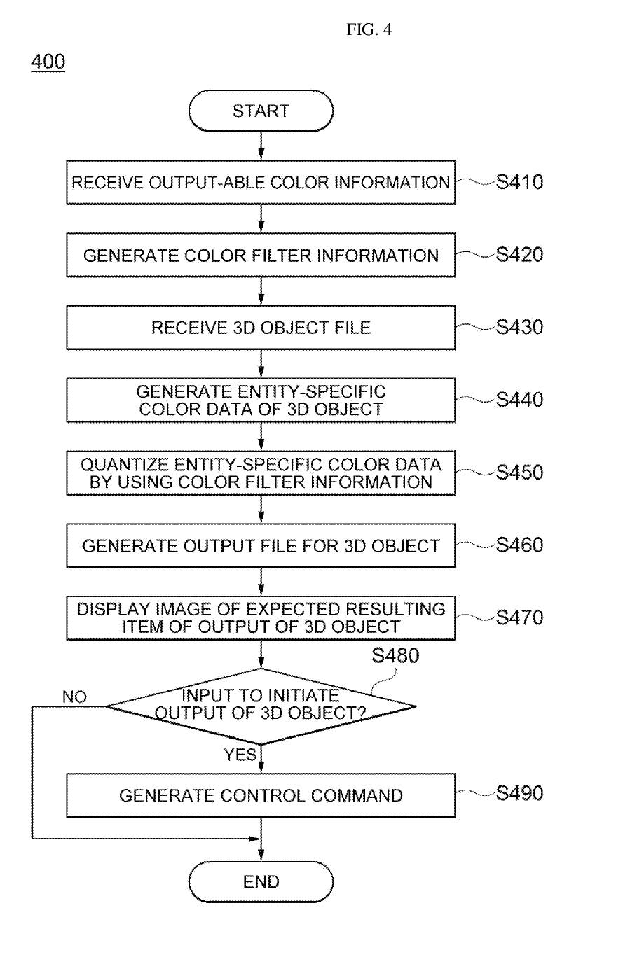

Hereinafter, a process of controlling multicolor 3D printing according to an exemplary embodiment will be described with reference to FIG. 4. For example, operations included in a process 400 for multicolor 3D printing shown in FIG. 4 may be performed by the apparatus for control of multicolor 3D printing 120.

After an initiation operation, the process 400 proceeds with operation S410. In the operation S410, the color filter information generation unit 121 receives output-able color information for designating a plurality of colors that are available for use in the 3D printer 130.

In operation 5420, based on the output-able color information, the color filter information generation unit 121 may generate color filter information representing a plurality of output-able colors according to a predetermined color model. The color model may be one of various models for representing colors of a 3D object, such as an RGB model, a CMY model, an HIS model and a YCbCr model. For example, the generated color filter information may have a data structure such as the 3D vector array 200 described above.

In operation 5430, the color data generation unit 122 may receive a 3D object file including modeling information about a 3D object. Examples of the 3D object file may include a file generated through 3D modeling software, such as CAD, (for example, a CAD file), a file generated through a 3D scanner and including appearance information, color information and texture information about a 3D object, and a file being able to be acquired from a 3D content market, such as Thingiverse (for example, an STL file and an AMF file).

In operation 5440, based on the modeling information about the 3D object, the color data generation unit 122 generates entity-specific color data representing a color of each entity forming the 3D object.

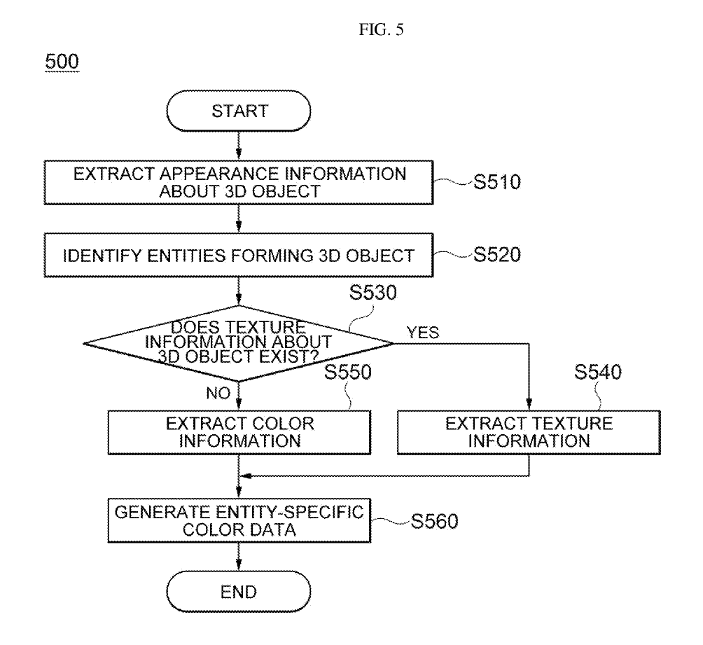

For example, FIG. 5 shows a process of generating the entity-specific color data according to an exemplary embodiment of the present disclosure.

According to a process 500 shown in FIG. 5, the color data generation unit 122 may extract appearance information about the 3D object from the 3D object file (S510).

The color data generation unit 122 may identify entities forming the 3D object (for example, an “Object” entity, a “Part” entity, a “Polygon Mesh” entity, a “Voxel” entity, and/or a “Layer” entity) based on the extracted appearance information (S520).

The color data generation unit 122 may not only identify each entity of the 3D object by extracting the appearance information of the 3D object from the modeling information about the 3D object, but also generate entity-specific color data by extracting at least one of texture information and color information about the 3D object from the modeling information.

For example, referring to FIG. 5, the color data generation unit 122 may determine whether texture information about a 3D object is included in the 3D object file (S530). The texture information may include a texture map allocated to the 3D object by using a 3D modeling tool. The texture information may represent a texture mapping to each entity of the 3D object (for example, image texture and/or procedural texture) in place of a color of each entity of the 3D object.

If it is determined as a result of the operation S530 that texture information exists, the color data generation unit 122 may extract the texture information from the 3D object file (S540). Then, the color data generation unit 122 may generate entity-specific color data based on the texture information (S560).

If it is determined as a result of the operation S530 that texture information does not exist, the color data generation unit 122 may extract color information that represents a color mapping to each entity from the 3D object file (S550). Then, the color data generation unit 122 may generate entity-specific color data of the 3D object based on the color information (S560).

The entity-specific color data may represent the color of each entity of the 3D object according to a predetermined color model. The color model may be selected from various models for representing colors of a 3D object, such as an RGB model, a CMY model, an HIS model, and a YCbCR model. For example, the generated entity-specific color data may have a data structure, such as the 3D vector array 300 described above.

Referring again to FIG. 4, quantization of the entity-specific color data will be described.

In operation S450, the color quantization unit 123 quantizes the entity-specific color data by using the color filter information. The quantized entity-specific color data represents one of a plurality of colors being able to be output by the 3D printer 130, as the color of each entity of the 3D object.

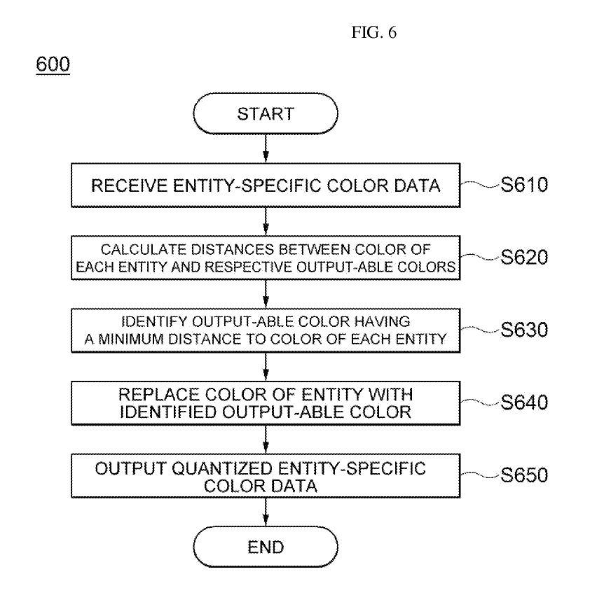

For example, FIG. 6 shows a process of quantizing entity-specific color data according to an exemplary embodiment of the present disclosure.

According to a process 600 shown in FIG. 6, the color quantization unit 123 may receive entity-specific color data (S610).

Then, the color quantization unit 123 may calculate distances between the color of each entity of the 3D object and the plurality of output-able colors according to a predetermined distance metric (S620). The distance metric may be Euclidean distance. For example, when the color filter information represents an output-able color as a coordinate value in a color space according to an RGB model (hereinafter, referred to as “a first coordinate value”) and the entity-specific color data represents the color of an entity of the 3D object as a coordinate value in the color space according to the RGB model (hereinafter, referred to as “a second coordinate value”), the color quantization unit 123 may calculate a Euclidean distance D between the first coordinate value and the second coordinate value through Equation 1 as shown below.

D=\sqrt{(Rₚ−Rₜ)+(Gₚ−Gₜ)²+(Bₚ−Bₜ)²} [Equation 1]

, wherein Rₜ, Gₜ and Bₜ represent an R value (that is, a value for red), a G value (that is, a value for green) and a B value (that is, a value for blue) of an entity of a 3D object, respectively. Rₚ, Gₚ and Bₚ represent an R value, a G value and a B value of an output-able color, respectively.

The color quantization unit 123 may identify an output-able color having a minimum distance to a color of each entity of a 3D object among a plurality of output-able colors through the above calculation (S630).

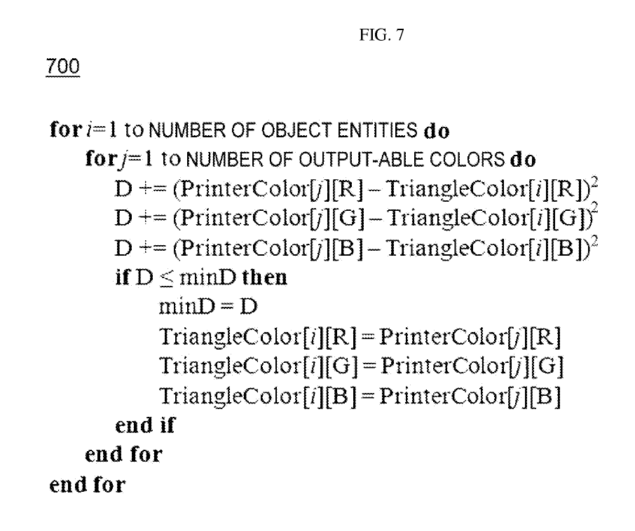

In order to replace the color of each entity of the 3D object with the output-able color having a minimum distance to the color of each entity, the color quantization unit 123 may convert the entity-specific color data such that a part representing a color of each entity in the entity-specific color data represents an identified output-able color (S640). For example, according to a pseudo-code 700 shown in FIG. 7, the color quantization unit 123 may perform the operations S620, S630 and S640 described above on each entity.

After the entity-specific color data is converted as described above, the color quantization unit 123 may output the quantized entity-specific color data (S650).

Referring again to FIG. 4, a process of generating an output file for the 3D object will be described.

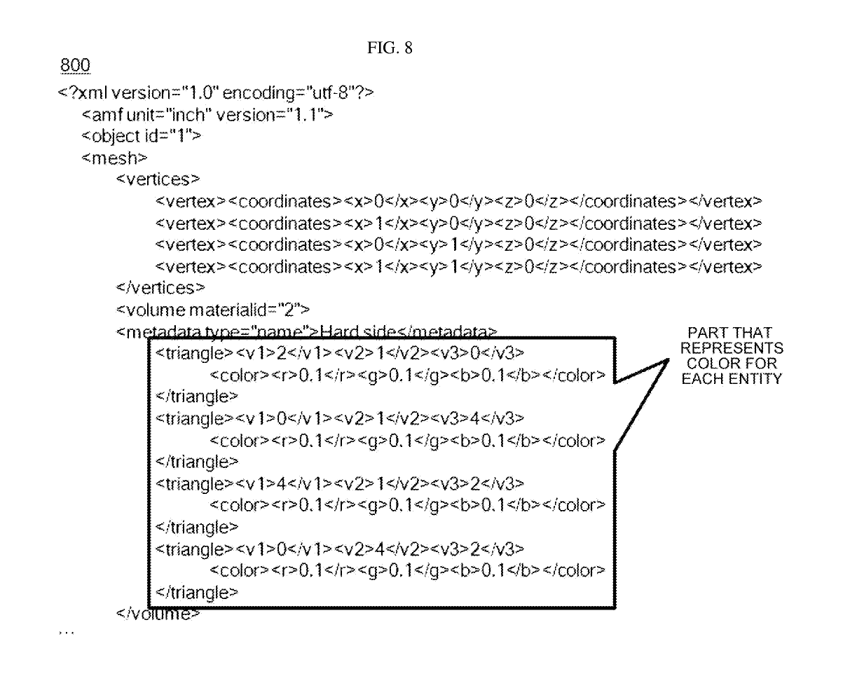

In operation S460, the output file generation unit 124 may generate an output file to be used for output of the 3D object from the modelling information about the 3D object and the quantized entity-specific color data. In particular, the generated output file may include the appearance information about the 3D object and the converted entity-specific color data. Examples of the output file of the 3D object may include files having various formats, such as an STL file and an AMF file. For example, the output file generation unit 124 may define an appearance of each entity forming a 3D object in an output file having an STL format (for example, a triangular entity), and then define a color of the entity as values represented by converted entity-specific color data (for example, an R value, a G value and a B value). Alternatively, the output file generation unit 124 may change color values represented by converted entity-specific color data according to another color model (for example, an sRGB model), define an appearance of each entity forming the 3D object in an output file having an AMP format (for example, a triangular entity), and then define a color of the entity as the changed color values. FIG. 8 is a diagram illustrating a part of an output file having an AMF format 800 according to an exemplary embodiment of the present disclosure.

In operation S470, the output file generation unit 124 generates an image of a resulting item expected to be output through the 3D printer 130 with respect to a 3D object, and displays the image. Accordingly, a user may check the displayed image and perform an input to initiate output of a 3D object, and the output file generation unit 124 may detect the user's input.

In operation S480, the output file generation unit 124 determines whether a user's input to initiate output of a 3D object is detected. If the user's input is not detected, the process 400 ends.

In operation S490, in response to the user's input, the control command generation unit 125 generates per-layer image data and/or a control command for output of the 3D object from the output file. For example, the control command generation unit 125 may generate per-layer image data and/or a control command by performing a slice process using the output file. Then, the control command transmission unit 126 may transmit the generated per-layer image data to the 3D printer 130 or transmit the generated control command to the 3D printer 130. Accordingly, the 3D printer 130 may output the 3D object by laminating materials.

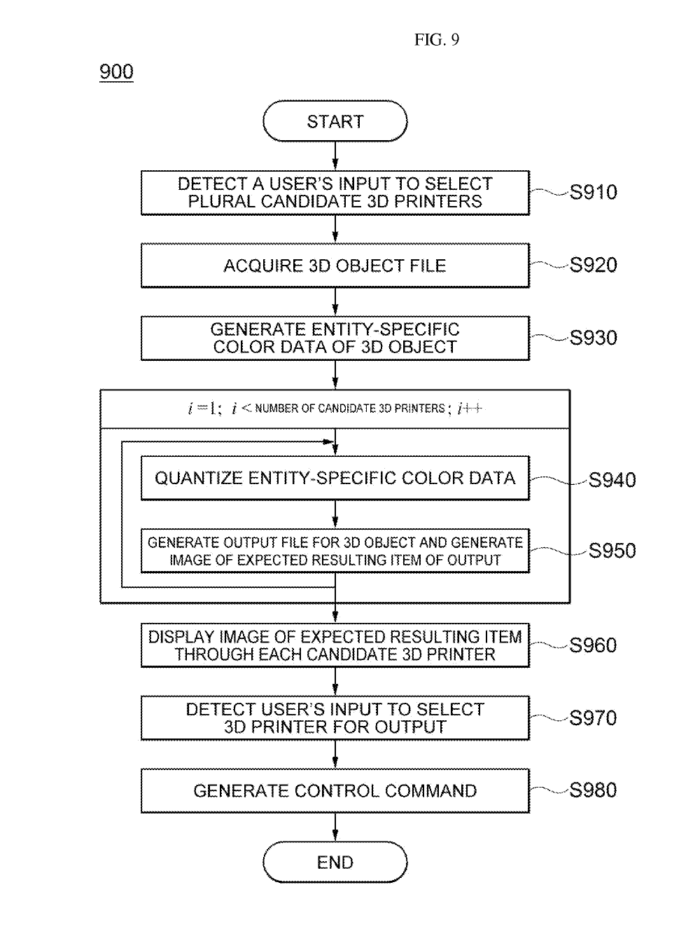

According to exemplary embodiments, the process for multicolor 3D printing 400 may be expanded to be applicable to an operating environment in which a plurality of 3D printers exist. FIG. 9 is a flowchart showing a process of controlling multicolor 3D printing suitable for such an operating environment. A process of controlling multicolor 3D printing 900 shown in FIG. 9 may be performed by the apparatus for control of multicolor 3D printing 120 of FIG. 1.

After an initiation operation, the process 900 proceeds with operation S910. In the operation S910, the color filter information generation unit 121 detects a user's input to select a plurality of candidate 3D printers. The color filter information generation unit 121 may generate color filter information representing output-able colors that are usable in each of the plurality of candidate 3D printers.

In operation S920, the color data generation unit 122 acquires a 3D object file including modeling information about a 3D object (for example, appearance information, texture information and color information).

In operation S930, the color data generation unit 122 generates entity-specific color data representing a color of each entity by identifying entities of the 3D object in a predetermined unit using the appearance information of the 3D object, and by using the texture information and/or color information of the 3D object.

In operation S940, with respect to the candidate 3D printer, the color quantization unit 123 quantizes the entity-specific color data by using the color filter information of the candidate 3D printer. The quantized entity-specific color data may represent the color of each entity as a color considered the most similar to an original color of the entity, among colors being able to be output through the candidate 3D printer, not as the original color.

In operation 5950, with respect to the candidate 3D printer, the output file generation unit 124 generates an output file by using the appearance information about the 3D object and the quantized entity-specific color data, and generates an image of an expected resulting item of output of the 3D object.

Operations S940 and 5950 may be repeated on each of the plurality of candidate 3D printers.

Operation 5960, the output file generation unit 124 displays the image of the expected resulting item of output of the 3D object through each candidate 3D printer. Accordingly, a user may check an image of an expected resulting item that is the most similar to a desired resulting item, among the plurality of images.

In operation 5970, the output file generation unit 124 detects a user's input to select one of the plurality of candidate 3D printers (hereinafter, referred to as “a 3D printer for output”)

In operation 5980, the control command generation unit 125 generates per-layer image data and/or a control command to output the 3D object based on the output file for the 3D printer for output. Then, the control command transmission unit 126 may transmit the generated per-layer image data to the 3D printer for output or transmit the generated control command to the 3D printer for output.

The present disclosure can also be embodied as a computer readable recording medium that includes a computer executable program configured to perform the methods described in the specification. The computer readable recording medium may be implemented in a program instruction, a local data file, and a local data structure, or in a combination of one or more of these. Meanwhile, the program recorded in the recoding medium may be designed and constructed for the present disclosure or easily constructed by a programmer in the field of computer software. Examples of the computer readable recording medium include a hardware device constructed to store and execute a program instruction, for example, a magnetic media such as a hard disk, a floppy disk, and a magnetic tape, optical media such as a CD-ROM, and a DVD, magneto-optical media such as floptical disk, read-only memory (ROM), random access memory (RAM), and flash memory. In addition, the program instruction may include a machine code made by a compiler, and a high-level language executable by a computer through an interpreter.

The above-described devices may be implemented using hardware components and software components. For example, the devices included in the 3D printing system 100 may be implemented using hardware components. The hardware components may include a processor and a memory.

The processor may be a controller and an arithmetic logic unit, a digital signal processor, a microcomputer, a field programmable array, a programmable logic unit, a microprocessor or any other device capable of responding to and executing instructions in a defined manner such that the processor is programmed with instructions that configure the processing device as a special purpose computer configured to perform the embodiments of the present disclosure.

For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The memory may be any device capable of storing data including magnetic storage, flash storage, etc.

As is apparent from the above, according to exemplary embodiments of the present disclosure, color data representing a color being able to be output by a 3D printer is included in an output file as a color of each entity of a 3D object together with modeling information about the 3D object (for example, appearance information about the 3D object), so that multicolor 3D printing can be effectively performed by using the output file.

According to exemplary embodiments of the present disclosure, an output file customized to be suitable for colors supported by a 3D printer can be generated by extracting color information from modeling information about a 3D object without having additional software or additional user's task.

According to exemplary embodiments of the present disclosure, detailed and sophisticated multicolor 3D printing can be performed.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. An apparatus for control of three-dimensional printing (3D printing), the apparatus comprising:
a color data generator configured to generate first entity-specific color data, representing colors of entities forming a 3D object based on modeling information about the 3D object;
a color quantizer configured to convert the first entity-specific color data into second entity-specific color data, by converting the colors of entities to match a plurality of output colors; and
an output file generator configured to generate an output file, to be used for output of the 3D object, from the modeling information and the second entity-specific color data.

2. The apparatus of claim 1, wherein the color data generator is further configured to identify the entities by extracting appearance information about the 3D object from the modeling information, and to generate the first entity-specific color data by extracting at least one from among texture information about the 3D object and color information about the 3D object from the modeling information.

3. The apparatus of claim 2, wherein the output file comprises the second entity-specific color data and the appearance information.

4. The apparatus of claim 1, further comprising a color filter information generator configured to generate color filter information representing the plurality of output colors,
wherein the color quantizer is further configured to convert the first entity-specific color data by using the color filter information,
wherein, according to a predetermined color model, the color filter information represent the plurality of output colors, and the first entity-specific color data represent the plurality of output colors and the colors of the entities.

5. The apparatus of claim 4, wherein the color model is selected among models that are usable for quantifying colors of the 3D object.

6. The apparatus of claim 1, wherein the color quantizer is further configured to identify an output color from among the plurality of output colors, having a minimum distance to a color of one of the entities, by calculating distances between the color of the one of the entities and the plurality of output colors according to a predetermined distance metric, and is further configured to convert the first entity-specific color data, wherein the color of the one of the entities is converted to match the identified output color.

7. The apparatus of claim 6, further comprising a color filter information generator configured to generate color filter information representing the plurality of output colors,
wherein one of the calculated distances is a distance between a first coordinate value and a second coordinate value, and the first coordinate value is a coordinate value of one of the plurality of output colors in a color space according to a color model, and the second coordinate value is a coordinate value of the color of the one of the entities in the color space.

8. The apparatus of claim 1, wherein the plurality of output colors are colors designated as being able to be output by a 3D printer.

9. The apparatus of claim 8, further comprising:
a control command generator configured to generate at least one of per-layer image data and a control command for output of the 3D object based on the output file; and
a control command transmitter configured to transmit the per-layer image data, in response to the per-layer image data being generated, to the 3D printer, and further configured to transmit the control command, in response to the control command being generated, to the 3D printer.

10. The apparatus of claim 1, wherein:
the color quantizer is further configured to convert a plurality of first entity-specific color data corresponding to a plurality of candidate 3D printers;
the output file generator is further configured to generate a plurality of output files corresponding to the plurality of candidate 3D printers;
the output file generator is configured to display an image of an expected resulting items of output of the 3D object through the plurality of candidate 3D printers by using the plurality of output files for the plurality of candidate 3D printers, and further configured to detect a user's input to select one of the plurality of candidate 3D printers; and
the apparatus for control of 3D printing further comprises a control command generator configured to generate at least one of per-layer image data and a control command for output of the 3D object based on the output file corresponding to the selected candidate 3D printer, and a control command transmitter configured to transmit the per-layer image data, in response to the per-layer image data being generated, to the selected candidate 3D printer, and further configured to transmit the control command, in response to the control command being generated, to the selected candidate 3D printer.

11. A method for control of three-dimensional printing (3D printing), the method comprising:
generating first entity-specific color data representing colors of entities forming a 3D object based on modeling information about the 3D object;
converting the first entity-specific color data into second entity-specific color data, by converting the colors of entities to match a plurality of output colors; and
generating an output file, to be used for output of the 3D object, from the modeling information and the second entity-specific color data.

12. The method of claim 11, wherein the generating of the first entity-specific color data comprises:
identifying the entities by extracting appearance information about the 3D object from the modeling information; and
generating the first entity-specific color data by extracting at least one from among texture information about the 3D object and color information about the 3D object from the modeling information.

13. The method of claim 12, wherein the output file comprises the second entity-specific color data and the appearance information.

14. The method of claim 11, further comprising generating color filter information representing the plurality of output colors,
wherein the converting of the first entity-specific color data comprises converting the first entity-specific color data by using the color filter information, and, according to a predetermined color model, the color filter information represent the plurality of output colors, and the first entity-specific color data represent the colors of the entities.

15. The method of claim 14, wherein the color model is selected among models that are usable for quantifying colors of the 3D object.

16. The method of claim 11, wherein the converting of the first entity-specific color data comprises:
identifying an output color from among the plurality of output colors, having a minimum distance to a color of one of the entities, by calculating distances between the color of the one of the entities and the plurality of output colors according to a predetermined distance metric, and
converting the first entity-specific color data, wherein the color of the one of the entities is converted to match the identified output color.

17. The method of claim 16, further comprising generating color filter information representing the plurality of output colors,
wherein one of the calculated distances is a distance between a first coordinate value and a second coordinate value, and the first coordinate value is a coordinate value of one of the plurality of output colors in a color space according to a color model, and the second coordinate value is a coordinate value of the color of the one of the entities in the color space.

18. The method of claim 11, wherein the plurality of output colors are colors designated as being able to be output by a 3D printer.

19. The method of claim 18, further comprising:
generating at least one of per-layer image data and a control command for output of the 3D object based on the output file;
in response to the per-layer image data being generated, transmitting the per-layer image data to the 3D printer; and
in response to the control command being generated, transmitting the control command to the 3D printer.

20. The method of claim 11, further comprising:
converting a plurality of first entity-specific color data to correspond to a plurality of candidate 3D printers;
generating a plurality of output files to correspond to the plurality of candidate 3D printers;
displaying an image of an expected resulting items of output of the 3D object through the plurality of candidate 3D printers by using the plurality of output files of the candidate 3D printers;
detecting a user's input to select one of the plurality of candidate 3D printers;
generating at least one of per-layer image data and a control command for output of the 3D object based on the output file corresponding to the selected candidate 3D printer;
in response to the per-layer image data being generated, transmitting the per-layer image data to the selected candidate 3D printer; and
in response to the control command being generated transmitting the control command to the selected candidate 3D printer.

21. A non-transitory computer-readable medium storing a program to make a computer execute the method described in claim 11.
